(19) United States
(12) Patent Application Publication
(10) Pub. No.: US 2007/0130536 A1
(43) Pub. Date: Jun. 7, 2007

(54) Interface display system and method

(75) Inventors: Chaucer Chiu, Taipei (TW); Sand Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/395,565

(22) Filed: Mar. 31, 2006

(30) Foreign Application Priority Data
Dec. 5, 2005 (TW) 94142734

(51) Int. Cl. G06F 9/00

(52) U.S. Cl. 715/781

(57) ABSTRACT

An interface display system for displaying an interface having a plurality of controllable objects includes a database for storing a plurality of programs for changing properties of the controllable objects of the interface; an operation analyzing module for receiving an operation and analyzing a type of the operation and the corresponding controllable objects; an object management module for calling at least one of the programs from the database corresponding to the type of the operation analyzed by the operation analyzing module and changing the properties of the corresponding controllable objects, thereby creating a corresponding object property table; and a window creating module for creating a window file according to the object property table. The present invention further proposes an interface display method. By the above system and method decreasing the interface update frequency is decreased and the interface display efficiency is increased.

### BACKGROUND OF THE INVENTION

1. Field of the Invention

The present invention relates to an interface display technology, and more particularly to an interface display system and method having a plurality of controllable objects.

2. Description of Related Art

With the development of science and technology, current application programs are usually provided with a user interface comprising a plurality of controllable objects. A user can operate any one of the controllable objects according to the need.

As shown in FIG. 1, a usual interface 1 comprises seven controllable objects: five buttons 11, a list 12 and a dialog 13. The user can operate the controllable objects such as move the dialog 13, click any one of the buttons 11 and switch focus between the buttons 11. These operations can change the display of the corresponding controllable objects of the interface, and application programs needs to update the interface display according to the operations of the user. However, in the conventional technology, the update process is based on each of the controllable object. That is, when a user performs an operation, the application program needs to create a plurality of window files, wherein each of the window files corresponds to a controllable object. According to this method, the interface 1 in FIG. 1 needs to be updated seven times. With the development of much more friendly interfaces, the number of controllable objects of an interface is increasing. If the above conventional technology is used, the interface display update frequency will become large and more seriously, the interface will flicker more frequently, thereby decreasing the interface display efficiency.

Currently, broadband networks are being widely used. The above conventional technology can also be applied to a network electronic display device such as a WiFi LCD TV. The interface display on such a WiFi LCD TV is usually controlled by a video transferring device such as a STB (set-top box). When a user performs an operation toward the interface having a plurality of controllable objects, the application program will create a plurality of image files corresponding to the plurality of controllable objects. The plurality of image files is further transferred to the display device for displaying. The defects of the display method are:

On one hand, each time when an image file is created and transferred to the display device, the interface display will be updated. Because of the transferring delay, a user will feel the flicker of the interface. Thus, the display efficiency of the display device is seriously and adversely affected.

On the other hand, image files will be created each time when an interface operation is performed. Because of the complexity of the image files, data volume that needs to be transferred also increases, which thus occupies a large bandwidth, thereby decreasing the transfer rate of the network.

Accordingly, there is a need to develop an interface display system and method which can decrease the update frequency of the interface display and increase the display efficiency.

### SUMMARY OF THE INVENTION

According to the above defects, an objective of the present invention is to provide an interface display system and method, which is applicable to an application program for interface display so as to decrease the update frequency of the interface display and increase the display efficiency.

Another objective of the present invention is to provide an interface display system and method applicable to a network electronic display device so as to decrease the data volume that needs to be transferred over the network and increase the transfer rate.

To achieve the above and other objectives, the present invention proposes an interface display system and method for displaying an interface having a plurality of controllable objects. The interface display system comprises: a database for storing a plurality of programs which can be used to change properties of the corresponding controllable objects of the interface; an operation analyzing module for receiving an operation and analyzing the type of the operation and corresponding controllable objects; an object management module for calling a program from the database in accordance with the type of the operation analyzed by the operation analyzing module and changing the properties of the corresponding controllable objects, thereby creating an object property table; and a window creating module for creating a window file according to the object property table.

In a preferred embodiment, the interface display system is embedded in a network electronic display device such as a WiFi LCD TV. The window file is an image file which can be displayed on the network electronic display device. The properties of the controllable objects include position property, size property, color property and state property. The type of operations can be an object moving operation, an object clicking operation, a focus switching operation and so on.

The interface display method of the present invention comprises the steps of: collecting and storing a plurality of programs for changing properties of the corresponding objects in a database; receiving an operation and analyzing the type of the operation and corresponding controllable objects; calling a program in accordance with the type of the operation and changing properties of the controllable objects, thereby creating an object property table; and finally, creating a window file according to the object property table and displaying the window file on a display device.

Thus, the interface display system and method of the present invention is characterized by integrating changed properties of the controllable objects to an object property table and creating a window file according to the object property table for displaying. When a user performs an operation toward the interface having a plurality of controllable objects, the interface display will be updated only one time. Compared with the conventional technology that needs to update the interface several times corresponding to the number of the controllable objects, the present invention can decrease the interface updating frequency and increasing the interface display efficiency. As a result, the interface can be displayed more clearly and fluently.

### BRIEF DESCRIPTION OF DRAWINGS

FIG. 1 is a diagram showing a usual interface comprising basic elements;

FIG. 2 is a block diagram of an interface display system of the present invention; and

FIG. 3 shows the basic steps of an interface display method of the present invention.

### DETAILED DESCRIPTION OF PREFERRED EMBODIMENTS

Hereunder, embodiments of the present invention will be described in full detail with reference to the accompanying drawings.

In the present embodiment, the interface display system and method is applied to a WiFi LCD TV for displaying an interface on a display screen of the WiFi LCD TV.

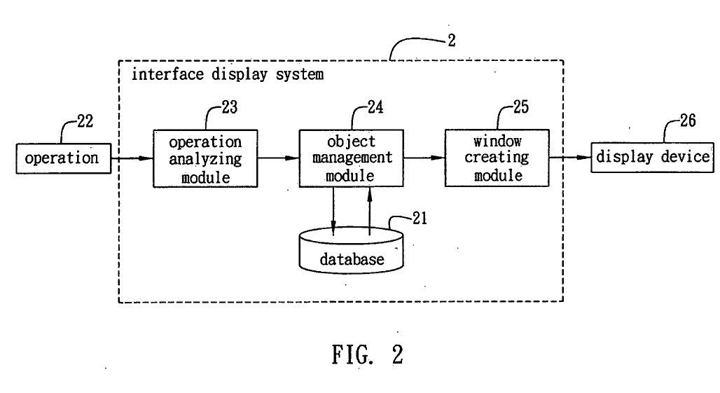

FIG. 2 is a block diagram showing a basic architecture of the interface display system of the present invention. The interface display system of the present invention is used to display an interface having a plurality of controllable objects. As shown in FIG. 2, the interface display system 2 comprises a database 21, an operation analyzing module 23, an object management module 24 and a window creating module 25.

In the present embodiment, the database 21 is embedded in an application program of a video transferring device. Meanwhile, the operation analyzing module 23, the object management module 24 and the window creating module 25 are embedded in an application program of the TV. Data can be wirelessly transferred between the signal transferring device and the TV.

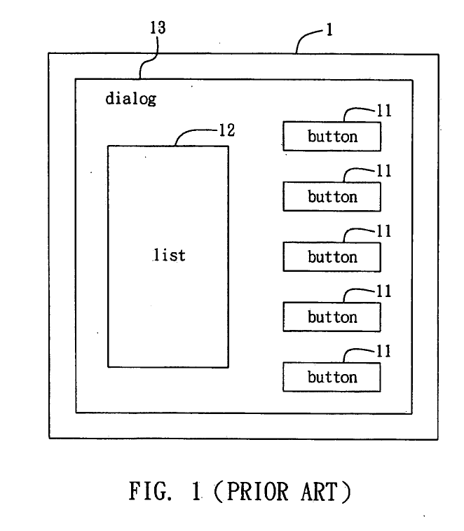

The database 21 of the interface display system 2 stores a plurality of programs which are used to change properties of the corresponding controllable objects of the interface. In the present embodiment, as shown in FIG. 1, the plurality of the controllable objects is a group consisting of five buttons 11, a list 12 and a dialog 13. The properties of the controllable objects includes position property such as coordinate property, size property, color property and state property such as click state and non-click state.

The operation analyzing module 23 is used to receive an operation 22 and analyze the type of the operation 22 and corresponding controllable objects. In the present embodiment, the type of the operation can be an object moving operation, an object clicking operation, a focus switching operation and so on. More specifically, an object moving operation refers to a dialog moving operation, a list moving operation or a button moving operation. The object clicking operation can be a dialog clicking operation, a list clicking operation or a button clicking operation. A focus switching operation refers to switching focus from one object to another. For example, the focus is switched from the list to a button.

The object management module 24 is used to call a program from the database 21 in accordance with the type of the operation analyzed by the operation analyzing module 23 and change the properties of the corresponding controllable objects such that a corresponding object property table can be created. When an operation is performed toward the interface, the properties of the corresponding controllable objects will be changed. As a result, the interface display is changed. For example, when a controllable object is clicked, the size property of the object is changed from small size to big size. When the display focus is switched to a controllable object, the color property of the object is changed from light color to dark color. When the properties of the corresponding controllable objects are changed by the program, an object property table is created to record the properties of all the controllable objects.

The window creating module 25 is used to create a window file according to the object property table. Thereafter, the window file is displayed in a display device 26. Therein, the window file is an image file created according to the properties of the controllable objects recorded in the object property table.

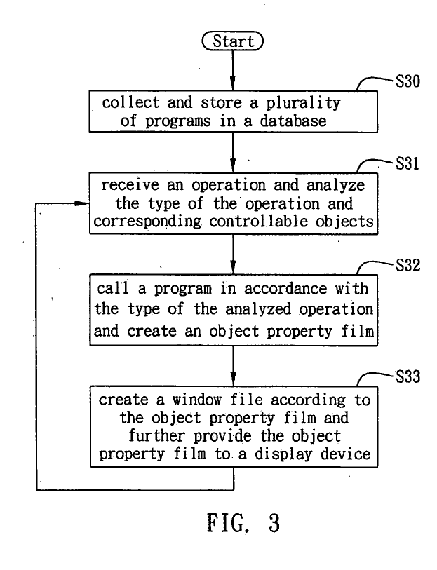

FIG. 3 shows a process flow of the interface display method of the present invention.

First, in step S30, a plurality of programs for changing properties of the corresponding objects is collected and stored in a database 21. Then, process flow moves to step S31.

In step S31, an operation is received and the type of the operation and corresponding controllable objects are analyzed. In the present embodiment, the operation refers to switching focus from a list to a button. Then, process flow moves to step S32.

In step S32, a program in accordance with the type of the operation analyzed in step S31 is called so as to change the properties of the controllable objects. Thereby, an object property table is created. In the present embodiment, the operation refers to a focus switching operation. The corresponding controllable objects are list and button. In the present step, a focus switching operation program in the database is called for calculating the position of the original focus (list coordinate value) and the position of the new focus (button coordinate value) and then changing the properties of the list and button. Therein, the color property of the list is changed from dark color to light color. The color property of the button is changed from light color to dark color. Thereafter, the properties of all the controllable objects are recorded in an object property table. Process flow moves to step S33.

In step S33, a window file is created according to the object property table and then displayed in a display device. Therein, the window file is an image file created according to the properties recorded in the object property table, which can be displayed on such as a LCD panel. Then, process flow moves back to step S31 in order to receive the next operation, change the properties of the corresponding controllable objects and creating a corresponding window file.

It should be noted that the controllable objects, the properties of the controllable objects, the types of operations and so on are not limited to the present embodiment.

Therefore, the interface display system and method of the present invention is characterized by integrating properties of all the controllable objects in an object property table such that a window file can be created according to the object property table for displaying. When a user performs an operation toward the interface, the interface display only needs to be updated one time. Compared with the conventional technology which needs to update the interface display a plurality of times corresponding to the number of the controllable objects, the present invention is more suitable to be applied to an interface having a large number of controllable objects, which not only reduces the updating frequency of the interface display, but also improves the interface display efficiency. Thus, the interface can be displayed more clearly and fluently.

When the present invention is applied to a wireless network electronic display device, since the display interface of the electronic display device only needs to be updated one time, a user will not feel the flicker of the interface, thereby ensuring the display efficiency of the display device. Further, since the wireless network only transfers the data describing the properties of the controllable objects instead of complex image files, the data volume that needs to be transferred is decreased and the transfer rate is increased.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An interface display system for displaying an interface having a plurality of controllable objects, comprising:
a database for storing a plurality of programs for changing properties of the controllable objects of the interface;
an operation analyzing module for receiving an operation and analyzing a type of the operation and the corresponding controllable objects;
an object management module for calling at least one of the programs from the database corresponding to the type of the operation analyzed by the operation analyzing module and changing the properties of the corresponding controllable objects, so as to create a corresponding object property table; and
a window creating module for creating a window file according to the object property table.

2. The interface display system of claim 1, wherein the interface display system is embedded in a network electronic display device.

3. The interface display system of claim 2, wherein the window file is displayed on the network electronic display device.

4. The interface display system of claim 1, wherein the window file is an image file.

5. The interface display system of claim 1, wherein the properties of the controllable objects comprise position property, size property, color property and state property.

6. The interface display system of claim 1, wherein the type of the operation comprises an object moving operation, an object clicking operation and a focus switching operation.

7. An interface display method for displaying an interface having a plurality of controllable objects, comprising the steps of:
(1) collecting and storing a plurality of programs for changing properties of the controllable objects in a database;
(2) receiving an operation and analyzing a type of the operation and the corresponding controllable objects;
(3) calling at least one of the programs from the database corresponding to the type of the operation analyzed in step (2) and changing the properties of the corresponding controllable objects, so as to create an object property table; and
(4) creating a window file according to the object property table.

8. The interface display method of claim 7, which is applicable to a network electronic display device.

9. The interface display method of claim 8, wherein the window file is displayed on the network electronic display device.

10. The interface display method of claim 7, wherein the window file is an image file.

11. The interface display method of claim 7, wherein the properties of the controllable objects comprise position property, size property, color property and state property.

12. The interface display method of claim 7, wherein the type of the operation comprises an object moving operation, an object clicking operation and a focus switching operation.
